(19) United States
(12) Patent Application Publication
(10) Pub. No.: US 2006/0094126 A1
(43) Pub. Date: May 4, 2006

(54) pH indicator for solid food called PHIND

(76) Inventor: Robert Gagnon, Sherbrooke (CA)

Correspondence Address: ROBERT GAGNON, 2875 DESCOTEAUX STREET, SHERBROOKE, QC, J1K 1N7, CA

(21) Appl. No.: 10/978,752

(22) Filed: Nov. 2, 2004

(51) Int. Cl. G01N 31/22; G01N 21/80

(52) U.S. Cl. 436/163; 422/56

(57) ABSTRACT

The pH indicator for solid food called PHIND is a detector that reveals the acidity of solid food. Because the acidity of human stomach is about pH 3 and because the possibilities of the body to neutralize excesses of acidity are limited, the sole fact of eating acidic food can cause discomfort or heartburns. The PHIND is specifically humidified to turn red as soon as it is on contact with an acidic food even if this acidic food is solid, warning people of the danger of discomfort or heartburns. Sealed in a watertight and chemically neutral envelope to keep its properties in all circumstances, the PHIND is always ready to reveal the acidity of solid food. The PHIND is effective, easy to use and disposable.

### FIELD OF INVENTION

The present invention is directed to a reactive apparatus for revealing the acidity of solid food, in particular, to a reactive apparatus humidified by a distilled water in order to have dissolution on contact with an acidic solid food.

### BACKGROUND OF THE INVENTION

We know that blue litmus paper is a pH indicator of a solution. The pH scale is also known: for examples, a pH of 7.0=neutral, a pH of 4.0=moderately acidic, a pH of 2.0=very acidic. We also know that the pH of a human stomach is about 2.0-3.0. A blue litmus paper begins to turn red on contact with a pH 4.5 solution but not on contact with a solid food even if this solid food is acidic because there is no dissolution, no absorption of a solid by a liquid. I discovered that a blue litmus paper turns red on contact with an acidic solid food only if this blue litmus paper is humidified by a distilled, chemically neutral, pH 7.0 water. Partly in solution, the properties of a blue litmus paper are not spoiled and a chemical reaction is possible even on contact with a solid food. See U.S. Pat. No. 5,403,721.

### SUMMARY

About pH indicators, we know that a blue litmus paper turns red when it is on contact with an acidic solution. In that case, we have a solid-liquid contact reaction. In the case of solid-solid contact, there is no reaction. If, for example, a blue litmus paper is on contact with an acidic solid food, it does not turn red; if it turns red, it does it very slowly even if the solid food is very acidic because there is no dissolution or a very slow-acting dissolution. In the present invention, a blue litmus paper is humidified by a distilled water. This humidification makes the blue litmus paper very effective even on contact with a solid food. In order to avoid contamination and to preserve humidity of the blue litmus paper, we seal this reactive apparatus in a protective envelope. Doing this, the PHIND is effective in every circumstances, easy to store, to carry, to use and disposable.

### DETAILED DESCRIPTION

There are many pH indicators and, about these indicators, only blue litmus paper is neutral, pH 7.0, and turns red on contact with a pH 4.5 or less than pH 4.5 solution. A blue litmus paper does not react on contact with a solid food even if this solid food is acidic because there is no dissolution, in other words, no absorption of a solid by a liquid that gives a solution. In order to have a chemical reaction, properties of blue litmus paper must be dissolved. Then, we have absorption of a solid by a liquid. To make it happens, we humidify a blue litmus paper by a pure water, a distilled, chemically neutral, pH 7.0 water. We seal this PHIND in a watertight, chemically neutral envelope. Doing this, properties of the PHIND are not spoiled and the PHIND stays wet. When we want to know if a solid food is acidic, we open the envelope and we put a sample of the solid food on the PHIND. This PHIND will react in a few seconds. If the PHIND does not turn red, we have a nonacidic or a low- acidic solid food. If the PHIND turns red, we have a moderately acidic, pH 4.5, or a true acidic, pH less than 4.5, solid food. In most cases, the redder the more acidic.

The embodiments of the invention in which an exclusive property or privilege is claimed are defined as follows:

1. A reactive apparatus for the detection of the acidity of solid food comprising a litmus paper humidified by a distilled water.

2. A reactive apparatus as defined in claim 1, in which the said litmus paper is a bluish or a blue litmus paper.

3. A reactive apparatus as defined in claim 1 and in claim 2, in which the said blue litmus paper is humidified by a distilled, chemically neutral, pH 7.0 water.

4. A reactive apparatus as defined in claim 1, in claim 2 and in claim 3, in which the said blue colour of the said humidified litmus paper turns red on contact with a pH 4.5 or less than pH 4.5 solid food.
